(19) United States
(12) Patent Application Publication
(10) Pub. No.: US 2005/0060252 A1
(43) Pub. Date: Mar. 17, 2005

(54) Graphical software tool for modeling financial products

(76) Inventor: Andrew Doddington, London (GB)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/697,849

(22) Filed: Oct. 30, 2003

Related U.S. Application Data
(60) Provisional application No. 60/502,118, filed on Sep. 11, 2003.

(51) Int. Cl. G06F 17/60

(52) U.S. Cl. 705/35

(57) ABSTRACT

A graphical software tool for modeling financial products is provided. The graphical software tool presents a user with a palette of tools for constructing a financial model. Preferably, the financial model is graphically represented as a tree structure, which allows the model to be transformed into an XML format. In general, a tree structure includes a root entity having a set of attributes, along with zero or more child entities. In turn, each of the child entities can have their own attributes and children. In response to an input from a user, objects from the palette are selected and used to construct the financial model. The tool provides a graphical user interface that allows users to construct financial products by combining a series of objects—using GUI techniques such as “drag and drop” to simplify the construction process. Although a number of objects are provided as standard, these may be combined to provide new functionality. Once this has been done, the result may be saved as an addition to the built-in set of objects. This allows users to build up increasingly complex tool sets, to match their individual requirements.

### CROSS REFERENCE TO RELATED APPLICATIONS

This application claims the benefit of U.S. Provisional Application Ser. No. 60/502,118, filed by Andrew Doddington on Sep. 11, 2003 and entitled “Graphical Software Tool For Modeling Financial Products”, which is incorporated herein by reference.

### FIELD OF THE INVENTION

The present invention relates generally to graphical modeling tools, and, more particularly, to a graphical software tool for modeling financial products.

### BACKGROUND OF THE INVENTION

Despite being over twenty years old, the spreadsheet remains the standard tool of choice for modeling new financial products. However, the spreadsheet suffers from many limitations, including lack of graphical features, limited reuse capability, and poor support for subsequent processing. Accordingly, a need exists for new tools for modeling financial products.

### SUMMARY OF THE INVENTION

A graphical software tool for modeling financial products is provided. The graphical software tool presents a user with a palette of objects for constructing a financial model. Preferably, the financial model is graphically represented as a tree structure, which allows the model to be transformed into an XML format.

In response to an input from a user, objects from the palette are selected and used to construct the financial model. The tool provides a graphical user interface that allows users to construct financial products by combining a series of objects—using GUI techniques such as “drag and drop” to simplify the construction process.

A number of objects are provided as standard, and these may be combined to provide new functionality. Once this has been done, the result may be saved as an addition to the built-in set of objects. This allows users to build up increasingly complex tool sets, to match their individual requirements.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is an example of a financial product represented as a tree structure;

FIG. 2 is an example of a graphical modeling tool for modeling a financial product;

FIG. 3 is an example of a graphical modeling tool with an optional entity viewer/editor;

FIG. 4 is a more detailed view of an example entity viewer/editor; and

FIG. 5 shows an example of an entity with an inner structure, comprising a value stream and an exemplar.

### DESCRIPTION OF PREFERRED EMBODIMENTS

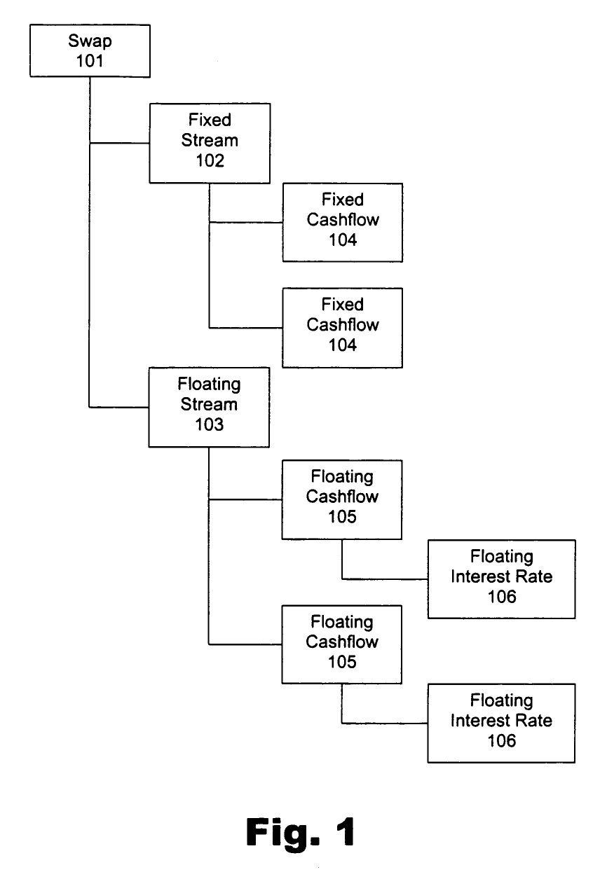

Most financial products can be represented using a tree structure. As an example, consider the representation of a plain vanilla interest rate swap. A plain vanilla interest rate swap is an agreement wherein two parties exchange a fixed set of payments for a floating set of payments, at specified dates in the future. Referring to FIG. 1, a plain vanilla swap is represented as a Swap entity 101 containing two child entities—a Fixed Stream 102 and a Floating Stream 103. The Fixed Stream contains two Fixed Cashflows 104, while the Floating Stream has two Floating Cashflows 105. The Fixed Cashflow amounts can typically be calculated when the product is first created, based on a fixed interest rate which is set at the Stream level—that is, the fixed rate is an attribute of the Fixed Stream entity. By contrast, the two Floating Cashflows must be calculated using the value of a corresponding Floating Interest Rate 106, which is published by some external party—typically on a daily basis.

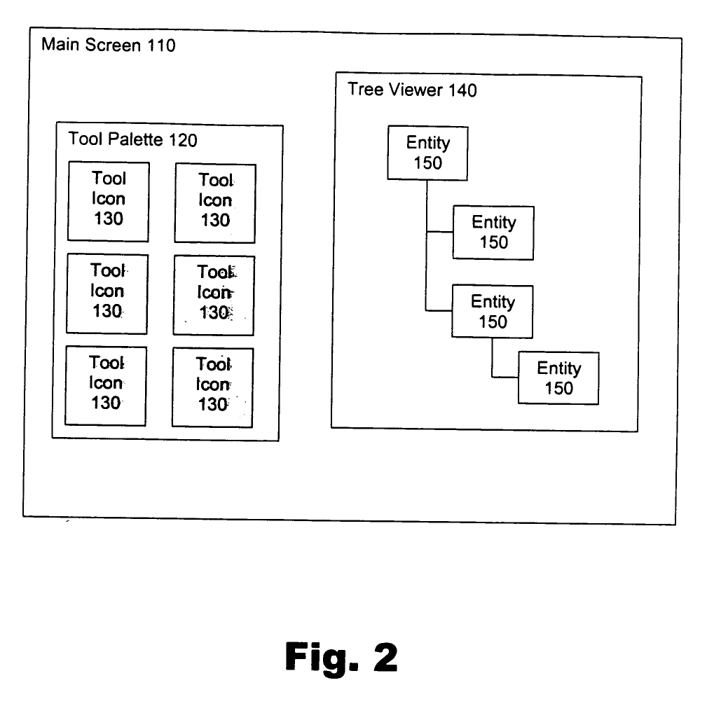

FIG. 2 illustrates an exemplary graphical software tool for modeling financial products. This graphical software tool can model a financial product as a tree structure.

As shown in FIG. 2, the tool includes a Main Screen 110 that contains two sub-screens: a Tool Palette 120 for displaying a series of Tool Icons 130; and a Tree Viewer for displaying the current product as a hierarchy of entities 150. The Tool Icons will typically use a descriptive picture to represent each tool, to aid the user in the task of selecting which tool to use. The actual selection process may make use of any number of standard graphical user interface (GUI) techniques, such as, for example, “dragging and dropping” the selected tool or selecting the parent entity and then double-clicking the palette entry to select the new entity that is to be added to the parent.

Initially, the user is provided with a standard set of tools, corresponding to the fundamental product components that are applicable to the business area in which the user operates. However, over time, the user may add to this palette, based on new components that they have created by combining the existing tools to product new forms. In general, these new forms will consist of sub-trees of a product. However, an entire product could be saved as a re-usable tool—corresponding to a re-usable product type. Preferably, this operation will be invoked either by the user dragging a selection box around the required sub-tree, or by the user selecting the root entity of the sub-tree and then invoking a “save sub-tree” facility (e.g. by using a menu option). Other forms of tool management facilities may be provided by the application, including the ability to rename tools or to facilitate the sharing of tools between different groups of users.

One benefit of the tree structure is that standard GUI facilities may be used to allow the user to expand or contract various parts of the tree display e.g. to aid navigation around the tree. A second major benefit of this approach is that it lends itself naturally to an Extensible Mark-up Language (XML) representation, where the structure of the XML form can correspond to the tree structure of the financial product upon which it is based. In this view, each of the entities in a product structure may be considered as XML Elements, while each of the entity attributes may be considered as XML Attributes. As an example, a swap trade could have a set of attributes, such as, for example, a trade effective date, a trade termination date, and the currency on which it is based. An example of a swap modeled in XML format is shown in Appendix A. Note that this model presumes the existence of a built-in function called “RATE( )” for getting an external interest rate, based on a rate index and a sample date. Although a tree structure is useful, it should be appreciated that other structures may also be supported, including grids or arbitrary webs of entities.

Further details concerning the XML standard are available from the World-Wide Web Consortium (W3C) at the url: http://www.w3.org. In particular, the XML standard is available at the url: http://www.w3.org/XML/. In addition, a number of books have been published on the subject, including: XML in a Nutshell, 2nd Edition, O'Reilly & Associates, 2nd edition (Jun. 15, 2002), ISBN: 0596002920; and Beginning XML, Second Edition, Wrox; 2nd edition (December 2001), ISBN: 0764543946, both of which are herein incorporated by reference in their entirety.

Viewing the product as an XML document allows a number of useful XML-related technologies to be applied to the product. As an example, consider XML Schemas, which are used to define the valid structures for XML documents. Treating the product as an XML document allows such schemas to be used to determine the validity or otherwise of the product that has been created by the user. For example, if the current schema indicates that a valid product must contain exactly two Stream elements, then a product with more or fewer streams that this would be flagged as being in error. A further example of the way in which XML technologies may be used would be to employ XSLT stylesheets to transform the product into alternatives forms, e.g. to display to the user in a more human-friendly form, or to permit the product to be transmitted to an alternative computer program that employs a different product notation. A further application where XSLT might be used would be to transform the product into a form that can be sent to a sub-system for further processing, e.g. to calculate the market price of the product.

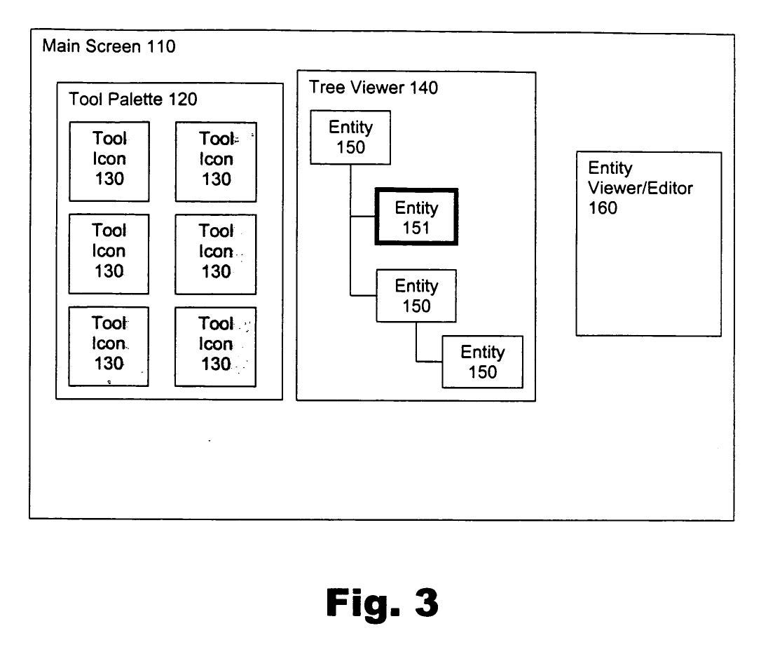

FIG. 3 shows an extension of the simple display in FIG. 2, in which one of the entities 151 in the tree display has been selected by the user, causing its attributes to be displayed in an Entity Viewer window 160.

The Entity Viewer may use a variety of mechanisms to display each entity, including customized data entry forms or other graphical displays. However, a simple mechanism that could be used for any entity, would be to display the attributes as a series of attribute names each with a corresponding attribute value.

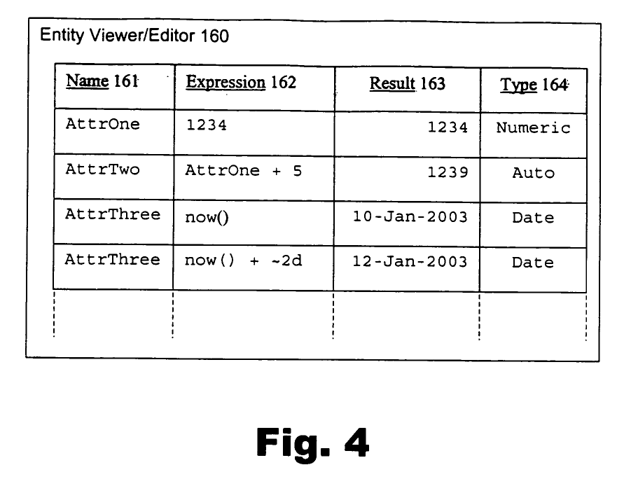

FIG. 4 shows part of an extended version of this form of Entity Viewer, which displays the list of attributes in tabular form, showing the attribute Name 161 and an Expression 162 that is associated with each attribute, along with the Result 163 of evaluating this expression. The attribute “AttrOne” has a simple expression comprising a single numeric value, which merely returns the same numeric value as its result. As a more complex example, “AttrTwo” calculates the value produced by adding “5” to the value of “AttrOne”. The other examples show how the expressions may support simple date arithmetic, e.g. to allow a two-day interval (expressed as “−2d”) to be added to the current day's date, as returned by the calling a function called “now ( )”. Other attribute features may be added to this viewer, including for example the expected Type of the expression result 164, which could be used for validation purposes.

A common situation that arises in financial modeling is that of a repeating series of child entities, each of which differs only slightly from its siblings, using parameters that are based on the characteristics of the parent entity or other entities in the product tree. As an example, a stream within a swap trade typically includes of a series of nearly identical Cashflows, which only differ from one another by the start- and end-date of the period in time to which they apply (that is, the period of time over which interest is accrued).

It would be cumbersome for the user to have to enter each cashflow manually, given their fundamental similarity. Therefore, to facilitate ease of use of the tool, certain entity categories can be classified as factories, which are capable of generating their own child entities.

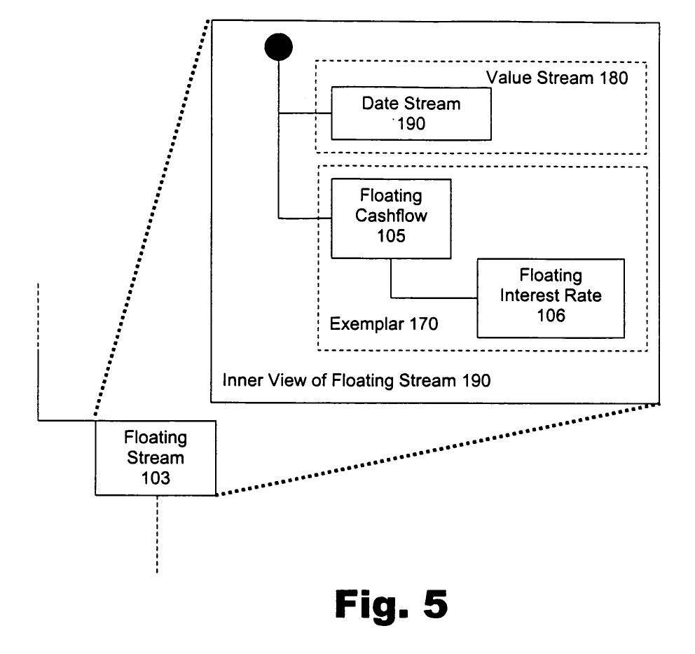

FIG. 5 shows an example of an Inner View 190 of a Floating Stream entity 103, which indicates that the inner view comprises a Value Stream 180 (based on a Date Stream 181) and an exemplar 170 *based on a Floating Cashflow 105 which has a child Floating Interest Rate entity 106).

Two basic types of factories are particularly useful:
A basic iterator factory that uses an exemplar and a value stream to generate child entities. The basic process is that the value stream generates a series of values (e.g. 1, 2, 3, . . . up until a pre-defined upper limit is reached) and that a copy of the exemplar is created for each value in this stream. The current value from the stream is inserted as an attribute of each copy, so that other attributes in this entity can use this value in their attribute expressions. The copied entity is then added as a new child of the factory entity which created it.
A between iterator factory, which operates in a similar manner to the previous case, except that it generates a new child entity for each “gap” between the sequence of values from the value stream. Thus if the stream consisted of the values 1, 2 and 3 then a copy would be created for the two pairs of values 1-2 and 2-3. In this case, each copy is passed the two values corresponding to the start and end of each gap.

A number of different value streams may be provided, including:
A simple integer stream, which takes a start value, an end value and a step.
A date stream, which operates in a similar manner to the integer stream but returns a regular series of dates, e.g. based on a start date, an end date and an interval.
An accrual stream, which generates a simple geometric series, e.g. based on a start value, a multiplier and an upper limit.

The children of a particular entity may generally be represented in a standard manner for trees, using the presentation shown in FIG. 1, in which they are clearly external to their parent entity. By contrast, the value stream and exemplar entities associated with a factory entity may be more properly considered as being internal to that entity, i.e. part of its inner state. This inner state may be accessed by logically “stepping-into” the containing factory entity, for example by double-clicking the entity or by selecting an appropriate menu option (e.g., using a pop-up menu).

The “inner view” of the entity can be represented as a tree structure, in the usual manner. One benefit of displaying the inner view in the standard manner is that it allows the user to maintain this inner state using the same mechanisms that are used for maintaining the outer view of the product.

The way in which this inner view is displayed may use a number of approaches, including physically expanding the containing “box” of the parent entity to display the inner view or to open a completely different tree viewer (updating the tool palette and entity viewer as necessary).

In general, an exemplar should be capable of being formed from any valid tree of entities, including the simple case of a single entity—e.g. a fixed cashflow. Indeed, there is no reason why an exemplar could not be formed from an entire product structure, e.g. if the parent trade needed to create a collection of child Swaps.

The preceding discussion has treated entities as basically self-contained and unaware of their environment. In practice, however, they are likely to be closely inter-dependent. As an example, the cashflows within a stream would generally be based on the currency that was defined for the trade. It is therefore evident that a mechanism is needed to allow entities to refer to one another's attributes. At this point, it is helpful to reconsider the entity viewer/editor 160. A simple viewer might display the entity attributes as a series of name/value pairs, as shown in FIG. 4. At it simplest, the input fields could be used to enter literal constants—e.g. numeric values, dates or strings. However, there is no reason why more complex expressions could not be allowed—including references to other entities or even to the current entity itself. This would allow one attribute of an entity to be derived from a combination of one or more other attributes of the same entity.

If each attribute has a unique name (unique within each entity, that is) then this provides a way of referring to it. In the interests of convenience, it is helpful if some degree of intelligence is provided so that if a given name does not exist in the current entity then a search is performed, stepping up the tree hierarchy until a matching name is found. This will also have the desirable side-effect of allowing us to move an entity in the tree, using the name-search capability to find the most appropriate matching attribute, based on the entity's new location.

However, if we wish to refer explicitly to an attribute of another entity then we may need to qualify it with its parent's name, in order to avoid ambiguity. As an example, consider a swap trade similar to the example shown in FIG. 1. If a cashflow attribute refers to a “currency” attribute, then this might refer to an attribute belonging to the cashflow's parent stream entity, or the top-level swap entity. Rather than creating a new reference mechanism, we can make use once more of the fact that the tree structure may be considered as an XML document. This allows attribute reference to use the standard XML XPath notation, e.g. using the XPath given below:
Swap/FixedStream/@currency

to explicitly select the required currency attribute of the Fixed Stream entity that lies directly beneath the Swap entity.

The use of XPath's leads to a potential ambiguity (e.g. the “/” symbol used by XPath may alternatively be used as the divide operator in an attribute expression. In order to avoid this ambiguity, XPaths may optionally be enclosed in curly braces “{‘and ’}”, as shown in the example expression below:
{Swap/@notional}/100.0

This example indicates that the attribute value is to be calculated by dividing the value of the “notional” attribute of the Swap by one hundred.

In order to enhance its usefulness, the expression language supports the common standard data types, together with a number of less common types that are particularly useful when manipulating financial products (e.g. types that relate to dates and times). A list of typical data-types is shown in Table 2.

TABLE 2

| Data Type | Description |
|---|---|
| Integer | A 32-bit integer value. |
| Floating- | A double-precision floating point value (i.e. 32 bits) |
| point | |
| String | An arbitrary-length sequence of characters |
| Date | A specific day, represented by its day, month and year. |
| Time | A time in a day, represented by its hours and minutes |
| | value (using the 24-hour clock). |
| Date-Time | A combination of both a date and a time. |
| Interval | A difference between two Dates, Times or Date-Times, |
| | expressed as a combination of one or more of: years, |
| | months, days, hours, minutes and seconds. |

In addition to simple scalar functions a number of set-based functions are provided, which take sets of values or vectors as their argument. Such vectors may be produced using the standard XPath mechanisms—which are defined as being capable of referring both to individual values or sets of values. Table 3 shows some examples of functions that may be applied to such sets.

TABLE 3

| Function | Description |
|---|---|
| MAX | Returns the maximum value. |
| MIN | Returns the minimum value. |
| SUM | Returns the sum of all values. |
| PRODUCT | Returns the product of all values. |
| COUNT | Returns a count of the number of values. |
| FIRST | Returns the first value. |
| LAST | Returns the last value. |
| AVG | Returns the mean average of all of the values. |

Some forms of an entity may have a “return value” corresponding to the default value that is passed back to their parent entity. Examples include those cases where the returned value may be used by the parent to support its further processing—such as when an interest rate observation entity passes its value back to its parent cashflow entity, so that this may then be used to calculate a floating-rate cashflow value. Similarly, the value of a series of cashflows in a stream may be combined to produce a net cashflow value.

In general, all entities should be capable of returning a value, even if this capability is not used in all cases. One approach might be to identify one of the entity attributes as being the default “entity value” attribute, through a user-selectable flag in the entity viewer shown in FIG. 4.

Once the basic product structure has been created, it becomes desirable to be able to add certain additional behaviors that are not part of the product as such, but which add behaviours that are effectively orthogonal to the primary structure of the product.

In order to support this kind of behavior a new type of entity is introduced, known as a “Watcher”. These may be attached to any individual entity in the product and serve to monitor the state of the underlying product. Each Watcher has a set of expressions defined that typically refer to the underling model. The Watcher will be triggered if any of these expressions is updated as a result of a change in any of the underlying attributes (i.e. the attributes that are referenced by the watch expressions). The trigger may be configured to activate every time an underling value is updated, or only if the expression result changes.

A Watcher is attached to an existing entity by selecting an option from a pop-up menu. If this is done then the entity will be marked by the addition of an “eye” icon. The main feature that distinguishes different Watchers is the specific behavior that is invoked when a change is detected. The two main varieties are “Logging Watchers” and “Action Watchers”, as described in the following sections.

Logging Watchers are used to externalize the state of the product in some manner, e.g. to generate debugging information or to send status messages to a downstream application. As example, a logging Watcher could be attached to each cashflow in a product, to cause a message to be published whenever the cashflow value is re-calculated. The process of generating the output message may either use ad hoc code, or make use of standard tools such as XSLT to convert the internal representation of the product into an external form.

Action Watchers are used to carry out some behavior as a result of a change in the product, e.g. an attribute value exceeding some pre-defined threshold. The action may either be performed on the current product, or on some alternative product that is associated with the current one in some manner (e.g. by referring to the unique name of the product that it to be modified).

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

Appendix A—Sample XML Code Representing a Swap

<?xml version=“1.0” encoding=“UTF-8” ?>

- <swap>

- <!-- Trade level details, may be used by streams etc -->

<notional>10000</notional>
<currency>USD</currency>
<effectiveDate>2000-06-22</effectiveDate>
<terminationDate>2001-06-22</terminationDate>
<frequency>˜6m</frequency>
<owner>JPMC</owner>
<counterparty>AcmeInc</counterparty>
<fixedRate>5.0%</fixedRate>
<floatingRateIndex>LIBOR-6M</floatingRateIndex>

- <fixedStream>

- <!-- Stream of two cashflows, value based
on a fixed interest rate -->
- <cashflow>

<payer>{/swap/owner}</payer>
<payee>{/swap/counterparty}</payee>
<startDate>{/swap/effectiveDate}</startDate>
<endDate>startDate+{/swap/frequency} − ˜1d</endDate>
<dayCount>endDate − startDate</dayCount>
<amount>{/swap/flxedRate} * {swap/notional} *

dayCount/360</amount>

</cashflow>
- <cashflow>

<payer>{/swap/owner}</payer>
<payee>{/swap/counterparty}</payee>
<startDate>{../preceding-

sibling::cashflow[position( )=1]/
endDate} + ˜1d</startDate>

<endDate>startDate+{/swap/frequency} − ˜1d</endDate>
<dayCount>endDate − startDate</dayCount>
<amount>{/swap/fixedRate} * {swap/notional} *

dayCount/360</amount>

</cashflow>

</fixedStream>
- <floatingStream>

- <!-- Stream of two cashflows, value based
on a floating interest rate -->
- <cashflow>

<payer>{/swap/counterparty}</payer>
<payee>{/swap/owner}</payee>
<startDate>{/swap/effectiveDate}</startDate>
<endDate>startDate + {/swap/frequency} − ˜1d</endDate>
<dayCount>endDate − startDate</dayCount>
<amount>{./rate/value} * {swap/notional} *

dayCount/360</amount>

- <rate>

<value>RATE({/swap/floatingRateIndex},

{../../startDate})</value>

</rate>

</cashflow>

- <cashflow>

<payer>{/swap/counterparty}</payer>
<payee>{/swap/owner}</payee>
<startDate>{../preceding-

sibling::cashflow [position( )=1]/
endDate} + ˜1d</startDate>

<endDate>startDate + {/swap/frequency} − ˜1d</endDate>
<dayCount>endDate − startDate</dayCount>
<amount>{./rate/value} * {swap/notional} *

dayCount/360</amount>

- <rate>

<value>RATE({/swap/floatingRateIndex},

{../../startDate})</value>

</rate>

</cashflow>

</floatingStream>

</swap>

1. A method for modeling a financial product, comprising the steps of:
displaying a palette of objects for constructing a financial product;
displaying at least one window for graphically representing the financial product; and
selecting objects from the palette to construct the financial product.

2. The method of claim 1, wherein the graphical representation of the financial model is in the form of a tree structure.

3. The method of claim 2, wherein the tree structure corresponds to an XML document.

4. The method of claim 3, wherein an XML schema defines a valid structure for the XML document.

5. The method of claim 1, wherein selecting the objects from the palette includes dragging the objects from the palette to the window.

6. The method of claim 2, wherein the tree structure includes a hierarchy of entities.

7. The method of claim 6, further including displaying the attributes of an entity.

8. The method of claim 7, wherein displaying the attributes of a an entity includes displaying an attribute name and corresponding attribute values.

9. The method of claim 6, further including editing an entity using a data entry form.

10. The method of claim 6, further including providing a Factory entity.

11. The method of claim 6, further including providing a Watcher entity.

12. The method of claim 11, wherein the Watcher entity is a Logging Watcher entity.

13. The method of claim 11, wherein the Watcher entity is an Action Watcher entity.

14. A computer system for modeling a financial product, comprising:
a display device for displaying a palette of objects for constructing a financial product and a window for graphically representing the financial model;
an input device for selecting objects from the palette; and
a processor configured to construct the financial model using the selected objects.

15. The system of claim 14, wherein the graphical representation of the financial model is in the form of a tree structure.

16. The system of claim 15, wherein the tree structure corresponds to an XML document.

17. The system of claim 16, wherein an XML schema defines a valid structure for the XML document.

18. The system of claim 14, wherein the objects are selected by dragging the objects from the palette to the window.

19. The system of claim 15, wherein the tree structure includes a hierarchy of entities, each of the entities having at least one attribute name and a corresponding attribute value.

20. A program storage device readable by a machine, tangibly embodying a program of instructions executable on the machine to perform method steps for modeling a financial product, the method steps comprising:
displaying a palette of objects for constructing a financial product;
displaying at least one window for graphically representing the financial product; and
selecting objects from the palette to construct the financial product.
